(19) United States
(12) Patent Application Publication
(10) Pub. No.: US 2025/0094521 A1
(43) Pub. Date: Mar. 20, 2025

(54) GENERATIVE NAVIGATIONAL CORPUS

(71) Applicant: Google LLC, Mountain View, CA (US)

(72) Inventors: Victor Carbune, Zurich (CH); Arash Sadr, Belmont, CA (US); Matthew Sharifi, Kilchberg (CH)

(21) Appl. No.: 18/889,117

(22) Filed: Sep. 18, 2024

Related U.S. Application Data
(60) Provisional application No. 63/583,712, filed on Sep. 19, 2023.

(51) Int. Cl. G06F 16/958; G06F 16/955

(52) U.S. Cl. CPC G06F 16/958; G06F 16/9558

(57) ABSTRACT

Disclosed implementations relate to structures that support an on-demand navigational corpus. An example method involves receiving a navigation request from a client device pertaining to an intent, determining seed content associated with the navigation request, utilizing a large foundational model to create a web page incorporating the seed content, based on a navigation model, and the intent, and delivering the generated web page for presentation on the client device. The method enables efficient and personalized web page generation based on user intent, enhancing user experience and facilitating dynamic navigation using raw seed content.

### CROSS-REFERENCE TO RELATED APPLICATION

This application is a non-provisional of, and claims priority to, U.S. Provisional Application No. 63/583,712, filed on Sep. 19, 2023, entitled “Generative Navigational Corpus,” the disclosure of which is incorporated herein in its entirety.

### BACKGROUND

Users currently navigate a mostly statically generated web corpus. Each web site corresponds to a service that provides some value to the user. In a statically generated web corpus, web-pages each have a predetermined role and functionality, where a user navigates between them to consume certain content or achieve a particular goal. Traversing the current statically generated web corpus can begin from a search query or from a starting page that links to other content. The starting page can be a content aggregator or service aggregator. Although some web pages can be dynamically generated, these web pages are usually related to a particular type of entity and follow a template, e.g., a web page dynamically generated to show order information for a particular order, a shopping web page dynamically generated from information in a database, a course schedule web page generated for a student at a university, etc. Thus, some content is provided at execution time, but the type and structure of the content is known ahead of time. In other words, the values of known data elements are dynamic but the data elements themselves are known.

### SUMMARY

Disclosed implementations outline a technical approach through which users may navigate through a web corpus that is generated dynamically as they navigate content. In such a continuously generated web corpus both content (blocks of text, media, the UI), links to other pages, and more, are generated on-demand (i.e., as needed). In disclosed implementations, content creators contribute seeds (i.e., seed content) that are incorporated into the dynamic and personalized generated web corpus. To accomplish continuously generated content, disclosed implementations describe structures to support a generative navigational corpus, where the content of a web page is generated on-demand based on user intent, seed content, and navigational histories.

The details of one or more implementations are set forth in the accompanying drawings and the description below. Other features will be apparent from the description and drawings.

### BRIEF DESCRIPTION OF THE DRAWINGS

FIG. 1 illustrates an example environment for implementing a generative navigational corpus, according to some implementations.

FIG. 2 illustrates an example method for providing a navigational corpus, according to an implementation.

FIG. 3 illustrates an example method for providing seed content for a navigational corpus, according to an implementation.

FIG. 4 illustrates an example of a distributed computing environment that can be used to implement the described techniques, according to some implementations.

### DETAILED DESCRIPTION

Given the powerful capabilities of large models, service providers, such as web site operators, have adapted existing services to incorporate generative features, but this is done while mostly maintaining the existing structure. A technical problem with this existing structure is that it is statically generated and not designed for, and does not take full advantage of, the capabilities of large models. In contrast, disclosed techniques use large generative models to create a much more customized browsing experience that takes into account implicit intents along with the dynamics of going through one page to another, all conditioned on the page content and navigational process. This enables layout, content and links to be generated on the fly resulting in a completely dynamic web.

Implementations provide a novel structure as a technical solution, which is designed to maximize advantages provided by the generative capabilities of large generative models, thus providing a new consumption stream. The large generative models can include large language models (LLMs), large vision models (LVMs), and other large models. Collectively, these large models are referred to herein as a large foundational model. A large foundational model can be a large language model, a large vision model, or a combination of models. The large foundational model is at the center of the consumption experience and is able to generate individual building blocks of web-pages (text, image, video, audio, links, etc.) or even entire pages, for example holistically generating a layout for the building blocks that is presented to the user. In some implementations, the system may also access different specialized models to fill in images and/or text.

The novel structure, also referred to as a generative navigational corpus or generative navigation system, enables web pages to be generated for the user at the time the content is requested, taking into account various seed content, navigational traces, and, with user permission, aspects of the user. The generative navigation system may create content (e.g., web pages) in real-time and on-demand, i.e., as the content is requested, and on-the-fly. The pages created on-demand may wrap known pieces of information, referred to as seed content, in a manner that considers historical navigational traces as well as inferred or expressed user intent and user features, with user permission. Thus, using the disclosed techniques, the same seed content can result in various presentations, depending on intents, user features, etc.

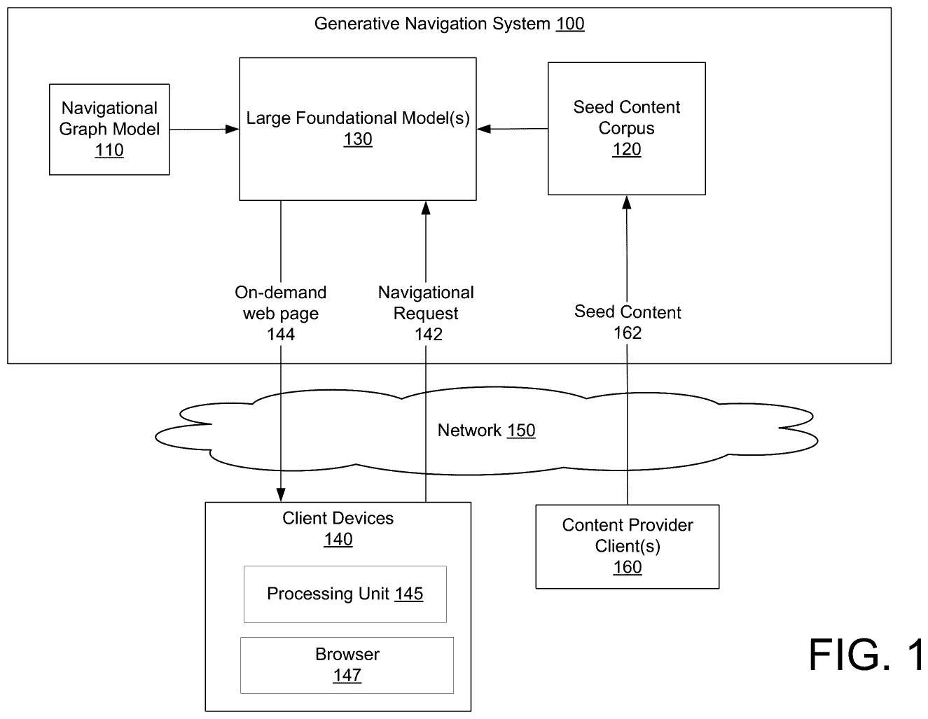

FIG. 1 is a diagram that illustrates example components of an environment for implementing the concepts described herein. In the example of FIG. 1, a generative navigation system 100 may be based on three interoperable structures. A first structure is a learned navigational graph model 110. The system of disclosed implementations learns the navigational graph model 110 from navigation dynamics based on queries, which may be inferred queries or provided queries. A provided query is a query received from a user. An inferred query is a query inferred from the context of navigation. For example, an inferred query may be blank if a user navigated directly to a resource (e.g., web page). An inferred query may be inferred from the prior resource, e.g., from the prior web page a user visited, based on context or content in the prior resource. An inferred query may be based on a navigational graph model for the domain of the prior resource. For example, the inferred query may be the most likely resource visited next in the domain given the prior resource. In some implementations, and with user consent, the likelihood may take into account aspects of the user, e.g., a class or interests of the user.

This learning phase for the navigational graph model 110 occurs without content-generation. The navigational graph model 110 may be initially based on (learned from) the current statically-generated web corpus, represented as a graph where each page is a node and edges (links) between nodes (pages) represent user transitions (navigations) from one page to another. Specifically, the navigational graph model 110 may learn how users transition from one content source to another content source, and therefore predict how a user might transition from one content source to another content source in the future. The learning may use any corpus of traces of user navigation sessions, using the traces for training the model to predict a navigation trajectory. The navigational graph model 110 may have a standard transformer architecture (e.g., encoder/decoder like T5, decoder-only like PaLM™, etc.).

The navigational graph model 110 may be trained in an unsupervised manner from navigational traces annotated with features. The features may describe various attributes of the content sources, the users, and/or the inferred queries. Some example features include features about the node of a navigation trace. A navigation trace is a directed graph linking nodes that represent resources (e.g., web pages) by edges that represent how a user arrived at the current node, i.e., a path from a root node to the current node. The root node in a navigation trace would be a resource (e.g., a web page represented by a URL or a domain) where a user started. The root node may be associated with a query. The query may be an inferred query. An inferred query may be blank if a user navigated directly to the web page. The query can be a provided query, i.e., associated with a user-provided search query. For example, the node may be a search result page generated for a user-provided query and/or the user may navigate to the web page from a search result page generated for the query. As a user navigates from the root node, other nodes may be added to the navigational trace. The other nodes are also associated with a query. The query can be an inferred query that is inferred from the prior page, from which the user navigated to the node. The features of a node may include a description of the web page. The features of a node may include the web page content (e.g., the HTML, the DOM tree, an accessibility tree) together with any additional metadata about the web page content. The features for the node may include an indication of the authors of the original content. This feature (the indication of the author(s)) can be used in conjunction with the next structure, a seed content corpus 120. Other features of the node can include the links the users followed from the node in the navigational trace. From these existing navigational traces, the navigational graph model 110 may learn to predict a next node given features of a current node, a current user, and/or a query (inferred or provided).

After training, at inference time, the navigational graph model 110 can be conditioned on any attributes and can generate the navigational trace itself, including predicting the attributes of a next node (or nodes). This can be used by the large foundational model 130 to generate navigational links for the user. As an example, the large foundational model 130 can use the navigational graph model 110 to generate links for an aggregator page, e.g., a web page that includes links a user might navigate to, including, for example, article titles, snippets, images, etc., that it would contain. As another example, the large foundational model 130 could be provided, e.g., as input, a user interface (e.g., a web page (HTML) that is real (e.g., hosted at a domain using conventional techniques) or was generated by the large foundational model 130) and use the navigational graph model 110 to suggest a next page, content for a next page, and/or links for a next page, where the large foundational model 130 generates the next page (based on the HTML of the nodes navigated previously and the user interface).

A second structure used in disclosed implementations is a seed content corpus 120. The seed content corpus 120 represents content contributions, e.g., seed content 162 from content providers using content provider client(s) 160. Content providers can be journalists, freelance writers, fiction writers, video creators, productivity writers, musicians, influencers, etc. The seed content 162 need not have a particular structure or form. Put another way, content providers today generate content in a finished or finalized form, e.g., paragraphs drafted for a particular audience. The seed content 162 is raw content and need not have a finished/finalized form. The raw content may be the core facts, opinions, character descriptions, plot descriptions, video shorts, images, or other information the content provider wants to include. In some implementations, seed content 162 may include content that comes from high-quality co-created content or content generated entirely on demand (e.g., a content provider may have their own generative model(s) they use to create seed content). Because the seed content 162 is raw content (not having a particular format or structure), the content providers can provide this content in any way best suited—as an audio snippet of any length, as pictures or videos, as text documents having any format. In disclosed implementations, the system (the large foundational model) generates the full content based on this raw content, i.e., the seed content.

Content providers may mark seed content with different tags. The tags can represent any criteria a content provider may set for use of the seed content. As non-limiting examples, tags can represent a level of sensitivity, a geographic area, a vertical (i.e., a category of content), or other criteria the content provider may use to limit use and/or distribution of the seed content. Thus, a content provider could tag seed content as appropriate for inclusion in (permitted for used in) any generated page for any page/domain, as appropriate for (permitted for use in) only a particular domain or domains, as appropriate for a page/domain categorized in a particular vertical (e.g., hiking, shopping, food, entertainment, travel, electronics, etc.), as not appropriate for a page/domain categorized in a particular vertical (e.g., as relating to adult content, a page relating to violent content, etc. and thus not appropriate for (not permitted for use in) a family game vertical/domain), as not appropriate for (not permitted for use in) a particular domain (or domains), as appropriate for (or as not appropriate for) a certain geographic area, etc. These tags may be as part of the seed content itself and/or provided as metadata for the seed content. Thus, the disclosed system enables a content provider to have control over what kinds of navigation requests the seed content is associated with. Put another way, a content provider can be associated with a domain, several domains, or all domains, certain verticals, certain geographic areas, all geographic areas, etc. The tags may be referred to as content criteria tags. Content criteria tags may be used to identify permitted uses and/or forbidden uses of the seed content.

The seed content corpus 120 is a body of this created content. The seed content in the seed content corpus 120 can be indexed in various ways, including by the content criteria tags or by an inverse index based on text of the seed content or a description of the seed content. As another example, a tag may relate to how content is presented when used to generate a web page. These tags may be referred to as content generation tags. Content generations tags may be used to select style preferences. For example, a content generation tag may specify a particular voice to be used when rendering audio, or a tag may indicate a preference for animations when the content is presented as an illustration, or a tag may indicate use of a particular tone (e.g., informal, formal, etc.) when the content is used. As another example, a tag may provide instructions for grouping a seed with other seeds, for example, to avoid grouping the seed content with other seed content related to a particular topic, or to only group the seed content with (permit grouping with) other seed content related to a particular topic. As another example, a tag may provide an indication of a preferred layout and/or format (article as opposed to comic/animation), etc. Tags (e.g., content criteria tags and/or content generation tags) can thus help a content creator to configure various aspects of how and when seed content is used.

The seed content 162 from the seed content corpus 120 may be processed in varied ways that can be incorporated in the third structure, which is a service for providing generative pages, i.e., on-demand web pages 144 generated on-demand from seed content selected based on query intents associated with a navigational request 142, to end users. This third structure is referred to as the large foundational model 130. In some examples, the large foundational model 130 may add additional seed content to the provided seed content, i.e., the seed content obtained from the seed content corpus 120 based on features of a navigational request 142, to generate even further related high-quality content that the creator hasn't thought of connecting—for example, text may be enriched with media “seeds” and vice-versa. As another example, the provided seed content may be surfaced to other creators connected to the seed content or inferred to be connected to the seed content by the generative navigation system 100. These other creators may provide seed content used to enrich the provided content.

In some implementations, content providers could be attributed and remunerated for their provided seeds. Remuneration may be based on how frequently a seed is surfaced to generate on-demand content, the frequency of interactions with a seed, or in other ways determined by the system. In some implementations, content creators (i.e., creators providing seed content) may be partially remunerated based on the amount of influence they have on the content served to the user, the interaction it triggers by the user, and/or using a model which splits the remuneration across the different seed providers used in a single generated web page. In some implementations, the system may associate weights with seed content when it generates content (at the next step), and may remunerate creators according to these weights as a proxy for frequency of use and value created to the end-user.

The large foundational model 130 is a service that generates web pages (on-demand web pages 144) from the seed content corpus to provide to content consumers using client devices 140 (users) in an on-demand fashion. In disclosed implementations on-demand means that the elements of the web page are not determined ahead of a request to generate the web page. The large foundational model 130 is the core of the service, which connects content providers (seed content) with the consumer (the user requesting content). The large foundational model 130 can put the same content into different formats (different web pages), depending on a number of factors. The factors can include the device type, for example, the display footprint (such as mobile, tablet, desktop, etc.). The factors can include user intent. The factors can include an inferred target consumer, or in other words aspects about the user, such as categories describing the user or settings selected by the user, which are obtained or determined with user permission. Thus, for example, the large foundational model 130 may generate an article (a first format) for a first user, a series of images (a second format) for a second user, a cartoon (a third format) for a third user, etc., from the same seed content. Thus, in disclosed implementations, the large foundational model 130 may determine a format of the web page in real-time, the format being based on multiple factors. The large foundational model 130 can be configured to provide attribution to content creators of seed content used in generating the web page. A web page as used herein is equivalent to a resource provided over a network, such as the Internet. Thus, a web page, as used herein, includes documents (including PDFs, word processing documents, spreadsheets, presentations, etc.), web applications, and media (e.g., image, sound, and video content). Thus, for example, a document, a web application, or video generated by the large foundational model 130 is considered a web page for the purposes of this disclosure.

The end-user may start their journey with a navigational request 142 having a desired implicit or explicit intent. This intent can vary and can be automatically inferred by the generative navigation system 100 or manually provided by the user. For example, the user may start their navigation session by going to a web page they normally visit each day (e.g., localnews.com). In the generative navigation system 100, this web page may be a real domain or a non-existent domain. For real domains, the generative navigation system 100 may map the existing URL to seed content provided by creators rather than a static web page or a web page with a static structure and dynamic content of a known type. There may be creators who provide seed content associated with official domains. The creators can be moderators or content curators who regularly push content to particular seeds in collaborative ways. The large foundational model 130 may take the seeds associated with the content address (e.g., the domain or a specific URL within the domain), would take the inferred user intent (e.g., why did the end user navigate to this URL), and the entire prior navigation history (e.g., from the navigational graph model 110) and perform a rank-and-retrieve step to first identify relevant seed content for the user related to the intent and then generate an on-the-fly the user interface (web page), including content generated from the identified seed content together with generated links (including title, snippet, and optionally images) to help the user further navigate. In some implementations, the large foundational model 130 may also take in a device type to ensure that the generated content is appropriate for a display footprint of the device (e.g., mobile, desktop, AR/VR display, etc.). The user may then click on a generated link and the process resets, but the large foundational model 130 is prompted with the current navigational trace as prompt so that further content can be generated. In disclosed implementations, the generative navigation system 100 may generate UI elements, media elements (images, videos, audio, etc.) and may optionally combine multiple seeds from one or multiple creators in unique ways.

In some implementations, the user may provide a non-existent URL or a query and start their journey this way. A non-existent URL is a locator address URL that cannot be resolved by a domain name service. Rather than returning an error, implementations may infer an intent from the non-existent URL. The large foundational model 130 may use the inferred intent (whether a query or from a non-existent URL) and generate an aggregation page, as described above, e.g., identifying seed content and/or real URLs (links), and generating UI elements and content from the seed content and links. With both non-existent URLs and queries, there may be an inferred intent that can be estimated and further refined by additional feedback the user provides. In some implementations, identification of links and seeds may be strongly conditioned on this initial intent that is determined and refined. In some implementations, the generated web page may include an indication (disclaimer) that the content was automatically generated.

In some implementations, the user may provide preferred configurations to the large foundational model 130, so that the content generated by the large foundational model 130 fits the user's preferences. For example, a user preference may indicate that content be generated for a particular device (phone, earbuds, AR/VR glasses, etc.). As another example a user preference may indicate a preference for a type of content, e.g., long form content, short form content, visual content, etc. As another example a user preference may indicate interest in a particular topic/area/entity, etc. such user preferences are provided with user permission and can help the user configure the content generation.

Putting all these structures together enables a dynamic web-corpus similar to what users experience today, but with completely different dynamics and services, tailored to each navigation, and potentially to each user, where a user gives permission for personalization. Personalization can be predicated on generalizations about a user, e.g., age groups, geographic regions, topics of interest, etc. Using disclosed implementations, the same seed content can result in different presentations of the seed content based on user characteristics (features). Thus, for example, a user categorized as a middle school student may have the same seed content presented in a different way than a user categorized as a college graduate (e.g., generalized education level). In an example, a first web page generated using a seed content for the middle school student may include more images, may be presented in the style of a comic or manga, and may use a middle school vocabulary, where a second web page generated using the same seed content for the college graduate may be presented in an article format with a college-level vocabulary and limited or different images. As another example, different seed content can be selected based on user characteristics, thus resulting in a different web page for the same non-existent URL (i.e., intent or inferred query). Thus, for example, the non-existent URL may be “greatesthikes.com” and a user accessing the URL in the United States may have first seed content selected, relating to hikes in the United States, where second seed content relating to hikes in Ireland may be selected for a user navigating to the same non-existent URL from Ireland.

The following examples are provided as aids for visualizing and explaining aspects of disclosed implementations and differences with statically-defined web pages and are not meant to be limiting. In a first example, a user starts with an exploratory navigation session on a news aggregator, e.g., a domain associated with “The Herald.” Using existing statically-defined web pages, the user goes into the page and gets to read through a few of the pre-written articles, possibly with the help of large language models (LLMs) for the text and large visual models (LVMs) for the images, which may make the page look a bit nicer or provide a summary of the articles/images. In contrast, using disclosed implementations, the user lands on the same page and may be presented with a list of generated titles and articles, e.g., generated using seed content selected for the user. The list of generated titles and articles may be based on an inferred navigational query (e.g., “explore what's new”, or “read about <x>,” “curious what related things are happening in tech,” etc.) attached to the navigational request. The list of generated titles and articles may be based on a previously modeled navigational process for a domain associated with “The Herald” itself, e.g., what links and content was followed through navigational traces previously observed. The links and content may be based on seed content associated with the domain for “The Herald”. The user may click through the most interesting piece of content they find on the page generated for them. The click results in a navigational query that includes the “title” and “snippet” of the selected link. In response to selecting the link, the user may be transported directly into some part of an article related to the title and snippet. The article can be a completely generated article or an article that is partially generated (e.g., the rest of the article is not yet available). The user may then scroll up or down in the generated article. As the user scrolls, content starts being generated on the fly, together with navigational links (e.g., additional navigations suggestions). The user may select (tap, click on) a navigational link. The navigational link may take the user to a separate article, repeating the process above. The navigational link may take the user into the same article, but with another part of it generated on-the-fly using this link.

A second example illustrates how content and service creators create seed content, and disclosed implementations serve dynamically-generated content using the seeds. Currently, in order to provide information and value to users, creators pay a service to maintain a web site or indirectly pay platforms for distributing content. Using disclosed implementations, creators can instead provide seed content to the dynamic web corpus. The seed content can include text, media, a good they sell, a service they offer, etc. The seed content need not be complete articles, a complete product layout, etc., but instead can include the main points that the content creator wants to convey without special formatting. These seeds would be surfaced by a relevancy mechanism of the disclosed implementations and fed into the large foundational model 130, which provides grounded & factual content appropriate for the requesting user. In some implementations, the relevancy mechanism may identify relevant seeds by mapping the inferred query into a latent space; mapping the seeds into the same latent space; then computing a distance function using an efficient nearest-neighbor system. In some implementations, the relevancy mechanism may perform a step where the most relevant seed used for generating the page based on the inferred query would be used during decoding and/or during re-ranking for grounding (e.g., evaluating the generated page for hallucinations or content that contradicts the most relevant seed (or seeds) used to generate the page.

The generated content may be provided in ways the content creator may not have imagined. As one example, the seed content may be a piece of opinion in a very raw form, but the generative navigation system 100 may have decided to present it accompanied with music that suits the user and/or the content of the opinion. As another example, the seed content may be provided as part of a bigger piece. Implementations enable content creators to focus on producing content while getting assistance from generative models for other aspects of the publishing task. Using disclosed implementations, creators may be remunerated when their seed content is used.

As shown in FIG. 1, the environment includes a network 150, e.g., a local area network (LAN), wide area network (WAN), the Internet, or a combination thereof, connects client devices 140, content provider client(s) 160, and the generative navigation system 100. In some examples, the network 150 can be accessed over a wired and/or a wireless communications link. For example, mobile computing devices, such as smartphones can utilize a cellular network to access the generative navigation system 100. In some examples, the generative navigation system 100 can access the web sites and/or the seed content corpus 120 via the Internet. For example, the seed content corpus 120 may include seed content stored at the generative navigation system 100 and/or stored at other servers accessible to the generative navigation system 100, such as at computing devices associated with the content provider. In some implementations, the seed content corpus 120 may be or may include an index that identifies the location of the seed content. Thus, in some implementations, the seed content corpus 120 may be or may include memory identifying a seed content corpus or portions of a seed content corpus. The generative navigation system 100 is thus configured to communicate with the client devices 140 and/or the content provider client(s) 160 via a network 150. The client devices 140 include at least a browser 147 and other applications (not shown), which are executed by at least one processing unit 145 for accessing the generative navigation system 100.

The client device 140 and/or the content provider clients 160 may include, among other things, a network interface, one or more processing units, memory, and a display interface. The network interface can include, for example, Ethernet adaptors, Token Ring adaptors, and the like, for converting electronic and/or optical signals received from the network 150 to electronic form for use by the client device 140 and/or content provider clients 160. The set of processing units includes one or more processing chips and/or assemblies. The memory includes both volatile memory (e.g., RAM) and non-volatile memory, such as one or more ROMs, disk drives, solid state drives, and the like. The set of processing units and the memory together form controlling circuitry, which is configured and arranged to carry out various methods and functions as described herein. The display interface is configured to provide data to a display device for rendering and display to a user.

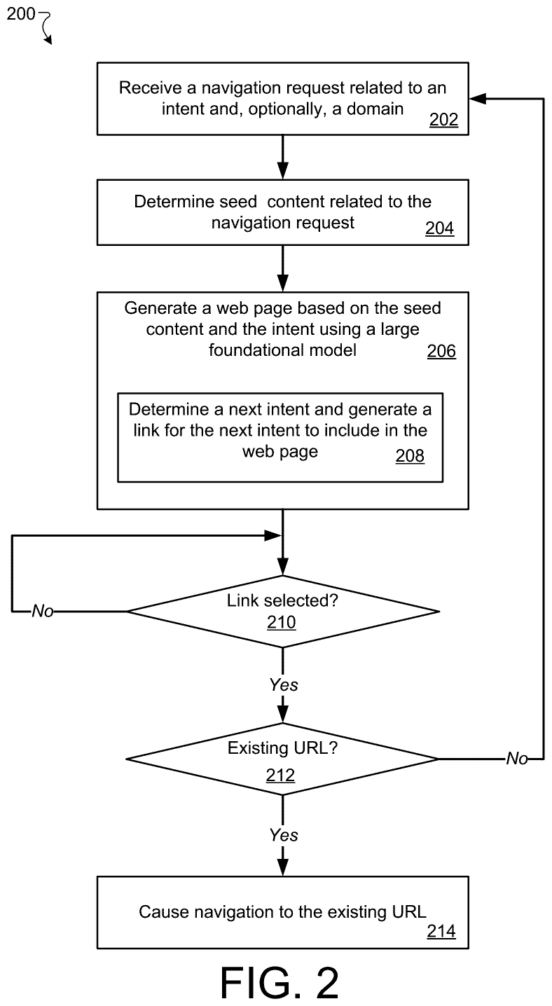

FIG. 2 is a diagram that illustrates an example method 200 for providing a navigational corpus, according to an implementation. Method 200 may be executed in an environment having a generative navigation system, such as the environment of FIG. 1. In some implementations, one or more of the method steps may be executed by a system, such as generative navigation system 100 of FIG. 1. In some implementations, one or more of the method steps may be performed at a client device, such as client devices 140 of FIG. 1. In some implementations, the environment may be an environment that includes conventional navigation and generative navigation. Not all steps need to be performed in some implementations. Additionally, the method steps can be performed in an order other than that depicted in FIG. 2.

Method 200 may begin with receiving a navigation request related to an intent (step 202). In some implementations, the navigation request may also be related to a domain. The intent can be an inferred query. The intent can be a received query. The domain may be an existing domain (e.g., resolvable by a domain name service). The domain may be a non-existent domain (e.g., not resolved by a domain name service). The navigation request can be associated with a navigation trace. A navigation trace represents a current browsing journey of the user.

At step 204, the system may determine seed content related to the navigation request. The seed content can be selected based on a domain, if one is provided. The seed content can be selected based on a navigation trace associated with the request. The seed content can be selected based on attributes of (features of) the user. The seed content can be selected based on attributes of (features of) the request, such as a generalized geographic location, a time of day, a time of year, etc. The seed content can be selected based on tags. The tags can be content generation tags. The tags can be content criteria tags. The tags can be a combination of content generation tags and content criteria tags. The tags can be associated with a domain (or subdomain) and applied to seed content for the domain (or subdomain). The tags can be associated with a profile of the user providing the seed content and applied to seed content from the user. The tags can be specific to the seed content. If a content criteria tag exists, the criteria (including a single criterion) must be satisfied for the seed content to be considered related to the navigation request. Put another way, the system may use the content criteria tags to determine whether the seed content is permitted for use for the navigation request.

At step 206, the system generates a web page based on the seed content and the intent using a large foundational model. In one example, the seed content may be provided to the large foundational model as input along with a context. The context may include a request to generate a web page from the input. Where content generation tags exist, the context may include the content generation tag or a description of the content generation tag. In some such implementations, a file (e.g., a media file) or a location of a media file identified by a content generation tag may be included in the context. In some implementations, and with user permission, the context may include attributes of the user associated with the intent. In some implementations, the seed content may include a citation identifier for other seed content. The citation identifier may enable the system to locate and include the other seed content in the generation of the web page.

As part of generating the web page, the system may determine a next intent/a plurality of next intents and generate a line/a plurality of links and include the links in the web page (step 208). The next intent may be determined using a navigational graph model. The navigational graph model may predict one or more next intents based on the seed content selected for generating the web page. The navigational graph model may predict one or more next intents based on the seed content selected and a current navigation trace. The navigational graph model may predict one or more next intents based on the seed content and attributes of the user (with user permission) or attributes of a class of user of which the current user is considered a member. The next intent can be a resource locator (a URL). The next intent can include an identifier/identifiers for seed content. The next intent can include a domain. The domain may be a real domain or a non-existent domain. The large foundational model may generate a title, e.g., link text, for each link. The large foundational model may include or generate an image for one or more links. The generated web page may have a different format depending on a number of factors, as described herein. Once the web page is generated, the system may provide the web page for display to the user.

If the user selects a link (step 210, Yes), the system may enable navigation to a next resource. If the link is associated with an existing URL (step 212, Yes), the system may enable or facilitate navigation to the existing URL (step 214). The system (e.g., a browser) may determine whether or not the link is associated with an existing URL based on whether a domain name service was able to resolve the URL. An existing URL will be resolved by the domain name service. If the domain name service returns an address not found error, the system may determine that the link is not associated with an existing URL (Step 212, No). In such a situation the system may treat the link as a new intent and start method 200 over again at step 202. In some implementations, even if a URL is resolved by the domain name service, the server associated with the domain may invoke method 200. For example, a domain may be or have access to a collection of seed content and may redirect a request to the generative navigation system for generation of the content (the web page). In such a system, the server associated with the domain may add additional information to the intent.

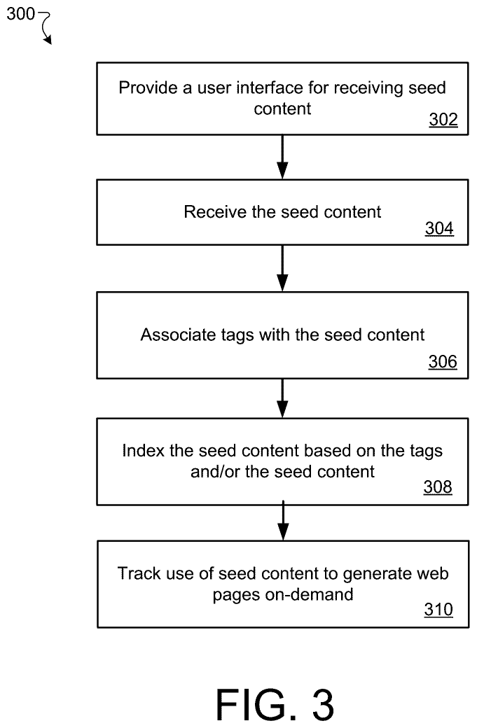

FIG. 3 illustrates an example method 300 for providing seed content for a navigational corpus, according to an implementation. Method 300 may be executed in an environment having a generative navigation system, such as the environment of FIG. 1. In some implementations, one or more of the method steps may be executed by a system, such as generative navigation system 100 of FIG. 1. In some implementations, one or more of the method steps may be performed at a client device, such as content provider clients 160 of FIG. 1. In some implementations, the environment may be an environment that includes conventional navigation and generative navigation. Not all steps need to be performed in some implementations. Additionally, the method steps can be performed in an order other than that depicted in FIG. 3.

Method 300 may begin at step 302 with the system providing a user interface for receiving seed content. The user interface may enable a content creator, e.g., a user of a content provider client, to provide new seed content (step 304). The seed content can include text. The seed content can identify another seed. The seed content can include images. The seed content can include audio (e.g., identification of an audio file) to be used with the seed content. The audio can be music to be used as a soundtrack. The audio can be an automated voice used for text-to-speech or for reading certain content. The audio file can include verbal instructions for generating a web page. The seed content does not have a particular format. In some implementations, the seed content does not include (lacks) mark-up language. In some implementations, the seed content does not include (lacks) titles. In some implementations, the seed content does not include (lacks) paragraph structure. The system may assign the seed content a unique identifier. In some implementations, the system may allow the content creator to provide a citation identifier for the seed content. The citation identifier may enable other seed content to refer to or include the seed content. Thus, the content provider can include the citation identifier of other seed content in the body of the seed content being received via the user interface. The other seed content identified may then be included by the system, e.g., the large foundational model, when dynamically generating a web page.

At step 306 the system may associate tags with the seed content. In some implementations, the system may receive tags, e.g., via the user interface, to associate with the seed content. The tags can be content generation tags. The tags can be content criteria tags. In some implementations, the system may associate the tags with the seed content by storing the tags as attributes of (metadata for) the seed content. In some implementations, the seed content may identify a content generation tag. In some implementations, the system may associate tags with seed content implicitly. For example, the seed content may be associated with a particular domain and any tags associated with the domain may be associated with seed content that is also associated with the domain. As another example, the content provider (the user using the interface) may have tags associated with their user profile and the system may associate those tags with the seed content. In some implementations, the user interface may enable a user to expressly disassociate one or more implicit tags with the seed content. Thus, a content criteria tag for the seed content may expressly indicate that a particular content criteria tag associated with the user and/or the domain does not apply to the seed content.

At step 308 the system may index the seed content. The system may index the seed content based on the tags. In some implementations only content criteria tags are used in indexing. In some implementations, certain content criteria tags are used in indexing. For example, content criteria tags related to a geographical area, to a particular entity, a particular domain, etc., may be indexed by those values. In some implementations, tags are not used for indexing. The system may index the seed content using known or later discovered techniques used to index documents, images, videos, and other such content. At step 310 the system may track use of seed content used to generate web pages on-demand. The tracking may enable the system to attribute and remunerate content providers.

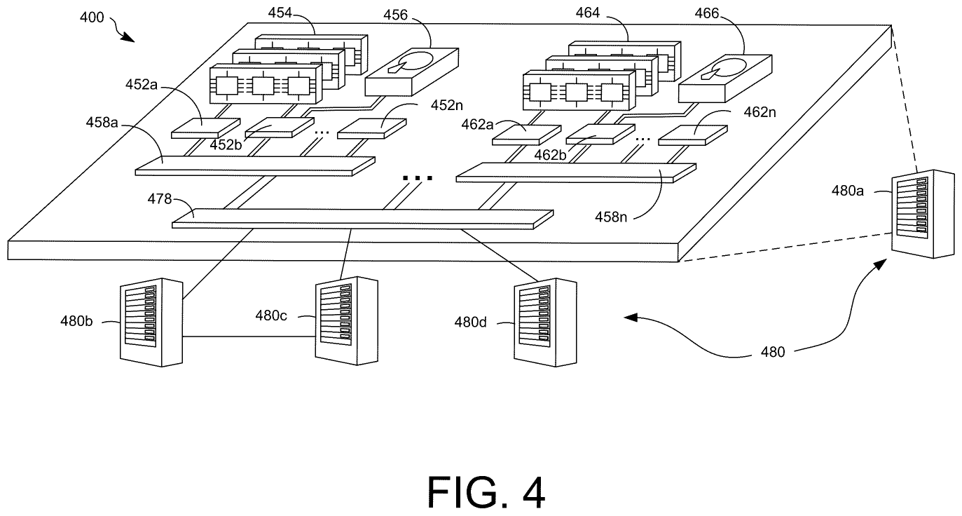

FIG. 4 shows an example of a computing device 400, which may be generative navigation system 100 of FIG. 1, which may be used with the techniques described here. Computing device 400 is intended to represent various example forms of large-scale data processing devices, such as servers, blade servers, datacenters, mainframes, and other large-scale computing devices. Computing device 400 may be a distributed system having multiple processors, possibly including network attached storage nodes, that are interconnected by one or more communication networks. The components shown here, their connections and relationships, and their functions, are meant to be examples only, and are not meant to limit implementations of the implementations described and/or claimed in this document.

Computing device 400 may be a distributed system that includes any number of computing devices 480 (e.g., computing device 480a, 480b, . . . 480n). Computing devices 480 may include a server or rack servers, mainframes, etc. communicating over a local or wide-area network, dedicated optical links, modems, bridges, routers, switches, wired or wireless networks, etc.

In some implementations, each computing device may include multiple racks. For example, computing device 480a includes multiple racks (e.g., racks 458a, . . . , 458n). Each rack may include one or more processors, such as processors 452a, 452b, . . . , 452n and 462a, 462b, . . . , 462n. The processors may include data processors, network attached storage devices, and other computer-controlled devices. In some implementations, one processor may operate as a master processor and control the scheduling and data distribution tasks. Processors may be interconnected through one or more rack switches 462a-462n, and one or more racks may be connected through switch 478. Switch 478 may handle communications between multiple connected computing devices 400.

Each rack may include memory, such as memory 454 and memory 464, and storage, such as 456 and 466. Storage 456 and 466 may provide mass storage and may include volatile or non-volatile storage, such as network-attached disks, floppy disks, hard disks, optical disks, tapes, flash memory or other similar solid state memory devices, or an array of devices, including devices in a storage area network or other configurations. Storage 456 or 466 may be shared between multiple processors, multiple racks, or multiple computing devices and may include a non-transitory computer-readable medium storing instructions executable by one or more of the processors. Memory 454 and 464 may include, e.g., volatile memory unit or units, a non-volatile memory unit or units, and/or other forms of non-transitory computer-readable media, such as a magnetic or optical disks, flash memory, cache, Random Access Memory (RAM), Read Only Memory (ROM), and combinations thereof. Memory, such as memory 454 may also be shared between processors 452a-452n. Data structures, such as an index, may be stored, for example, across storage 456 and memory 454. Computing device 400 may include other components not shown, such as controllers, buses, input/output devices, communications modules, etc.

An entire system may be made up of multiple computing devices 400 communicating with each other. For example, device 480a may communicate with devices 480b, 480c, and 480d, and these may collectively be known as generative navigation system 100, navigational graph model 110, large foundational model 130, and/or seed content corpus 120. Some of the computing devices may be located geographically close to each other, and others may be located geographically distant. The layout of computing device 400 is an example only and the system may take on other layouts or configurations.

Various implementations of the systems and techniques described herein can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described herein can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described herein can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described herein), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

A number of implementations have been described. Nevertheless, it will be understood that various modifications may be made without departing from the spirit and scope of the disclosed implementations.

In addition, the logic flows depicted in the figures do not require the particular order shown, or sequential order, to achieve desirable results. In addition, other steps may be provided, or steps may be eliminated, from the described flows, and other components may be added to, or removed from, the described systems.

In some aspects, the techniques described herein relate to a method including: receiving, from a client device, a navigation request related to a domain and an intent; determining seed content related to the navigation request and the domain; using a large foundational model to generate a web page based on the seed content, a navigation model, and the intent; and providing the web page for display on the client device.

In some aspects, the techniques described herein relate to a method, wherein the web page includes links, the links being represented by titles and snippets, the links, the titles, and the snippets being generated by the large foundational model.

In some aspects, the techniques described herein relate to a method, further including: receiving a selected link from the links; determining seed content related to the selected link; using the large foundational model to generate a second web page based on the seed content, the navigation model, and an inferred query based on the selected link; and providing the second web page for display on the client device.

In some aspects, the techniques described herein relate to a method, wherein a first seed content of the seed content includes a tag and determining the seed content related to the navigation request includes determining that the tag permits use of the first seed content for the navigation request.

In some aspects, the techniques described herein relate to a method, wherein the web page is a first web page and the large foundational model is configured to generate a second web page from the seed content based on features describing a different user, wherein the first web page has a different structure from the second web page.

In some aspects, the techniques described herein relate to a method, wherein the web page is generated based on the seed content, the navigation model, the intent, and features describing a user of the client device.

In some aspects, the techniques described herein relate to a method, wherein the navigation request is associated with a non-existent domain.

In some aspects, the techniques described herein relate to a method, wherein the large foundational model generates the web page based on preferences provided by a user.

In some aspects, the techniques described herein relate to a method, wherein the preferences include one of a device type, a topic, or a type of content.

In some aspects, the techniques described herein relate to a method, wherein a first seed content of the seed content includes a tag indicating criteria for grouping the first seed content with other seed content, and determining the seed content related to the navigation request includes determining that the tag permits grouping of the first seed content with remaining seed content.

In some aspects, the techniques described herein relate to a method, wherein a first seed content of the seed content includes a tag indicating a preference for content generated using the first seed content.

In some aspects, the techniques described herein relate to a method, wherein the preference is one of tone, layout, or format.

In some aspects, the techniques described herein relate to a method, wherein a first seed content of the seed content is used to ground the web page.

In some aspects, the techniques described herein relate to a method including: receiving, from a client device, a navigation request related to an intent; determining seed content related to the navigation request; using a large foundational model to generate a web page based on the seed content, a navigation model, and the intent; and providing the web page for display on the client device.

In some aspects, the techniques described herein relate to a method, wherein the navigation request is related to the intent and a domain and the seed content is determined to be related to the domain.

In some aspects, the techniques described herein relate to a method, wherein the web page includes links, the links being represented by titles and snippets, the links, the titles, and the snippets being generated by the large foundational model.

In some aspects, the techniques described herein relate to a method, further including: receiving a selected link from the links; determining seed content related to the selected link; using the large foundational model to generate a second web page based on the seed content, the navigation model, and an inferred query based on the selected link; and providing the second web page for display on the client device.

In some aspects, the techniques described herein relate to a method, wherein a first seed content of the seed content includes a tag and determining the seed content related to the navigation request includes determining that the tag permits use of the first seed content for the navigation request.

In some aspects, the techniques described herein relate to a method, wherein the web page is a first web page and the large foundational model is configured to generate a second web page from the seed content based on features describing a different user, wherein the first web page has a different structure from the second web page.

In some aspects, the techniques described herein relate to a method, wherein the web page is generated based on the seed content, the navigation model, the intent, and features describing a user of the client device.

In some aspects, the techniques described herein relate to a method, wherein the navigation request is associated with a non-existent domain.

In some aspects, the techniques described herein relate to a method, wherein the large foundational model generates the web page based on preferences provided by a user.

In some aspects, the techniques described herein relate to a method, wherein the preferences include one of a device type, a topic, or a type of content.

In some aspects, the techniques described herein relate to a method, wherein a first seed content of the seed content includes a tag indicating criteria for grouping the first seed content with other seed content, and determining the seed content related to the navigation request includes determining that the tag permits grouping of the first seed content with remaining seed content.

In some aspects, the techniques described herein relate to a method, wherein a first seed content of the seed content includes a tag indicating a preference for content generated using the first seed content.

In some aspects, the techniques described herein relate to a method, wherein the preference is one of tone, layout, or format.

In some aspects, the techniques described herein relate to a method, wherein a first seed content of the seed content is used to ground the web page.

In some aspects, the techniques described herein relate to a method including: receiving seed content, the seed content; associating at least one content generation tag or at least one content criteria tag with the seed content; indexing the seed content; using the seed content to generate a web page on-demand based on a navigation request associated with a non-existent domain; and providing the web page for display on a client device.

In some aspects, the techniques described herein relate to a method, wherein the content generation tag indicates a style preference.

In some aspects, the techniques described herein relate to a method, wherein the content criteria tag indicates a permitted use of the seed content.

In some aspects, the techniques described herein relate to a method, wherein the content generation tag or the content criteria tag is associated with a profile of a content creator providing the seed content.

In some aspects, the techniques described herein relate to a method, wherein a large foundational model is used to generate the web page based on the seed content and the content generation tag.

In some aspects, the techniques described herein relate to a method, further including: using the seed content to generate a link on a second web page, the link being generated using a navigational graph model; and using the seed content to generate the web page in response to selection of the link.

In some aspects, the techniques described herein relate to a method, wherein the seed content includes text lacking a finalized form.

In some aspects, a system includes at least one processor formed in a substrate and memory storing instructions that, when executed by the at least one processor, cause a computing device to perform any of the methods or operations disclosed herein.

In some aspects, a non-transitory computer-readable medium stores instructions that, when executed by at least one processor of a computing system, causes the computing system to perform any of the methods or operations disclosed herein.

What is claimed is:

1. A method comprising:
receiving, from a client device, a navigation request related to an intent;
determining seed content related to the navigation request;
using a large foundational model to generate a web page based on the seed content, a navigation model, and the intent; and
providing the web page for display on the client device.

2. The method of claim 1, wherein the navigation request is related to the intent and a domain and the seed content is determined to be related to the domain.

3. The method of claim 1, wherein the web page includes links, the links being represented by titles and snippets, the links, the titles, and the snippets being generated by the large foundational model.

4. The method of claim 3, further comprising:
receiving a selected link from the links;
determining seed content related to the selected link;
using the large foundational model to generate a second web page based on the seed content, the navigation model, and an inferred query based on the selected link; and
providing the second web page for display on the client device.

5. The method of claim 1, wherein a first seed content of the seed content includes a tag and determining the seed content related to the navigation request includes determining that the tag permits use of the first seed content for the navigation request.

6. The method of claim 5, wherein the web page is a first web page and the large foundational model is configured to generate a second web page from the seed content based on features describing a different user, wherein the first web page has a different structure from the second web page.

7. The method of claim 1, wherein the web page is generated based on the seed content, the navigation model, the intent, and features describing a user of the client device.

8. The method of claim 1, wherein the navigation request is associated with a non-existent domain.

9. The method of claim 1, wherein the large foundational model generates the web page based on preferences provided by a user.

10. The method of claim 9, wherein the preferences include one of a device type, a topic, or a type of content.

11. The method of claim 1, wherein a first seed content of the seed content includes a tag indicating criteria for grouping the first seed content with other seed content, and determining the seed content related to the navigation request includes determining that the tag permits grouping of the first seed content with remaining seed content.

12. The method of claim 1, wherein a first seed content of the seed content includes a tag indicating a preference for content generated using the first seed content.

13. The method of claim 12, wherein the preference is one of tone, layout, or format.

14. The method of claim 1, wherein a first seed content of the seed content is used to ground the web page.

15. A system comprising:
memory identifying a seed content corpus;
a navigational graph model;
at least one processor; and
memory storing instructions that, when executed by the at least one processor, causes the system to perform operations including:
receiving, from a client device, a navigation request related to an intent,
determining seed content from the seed content corpus that is related to the navigation request,
using a large foundational model to generate a web page based on the seed content, the navigational graph model, and the intent, and
providing the web page for display on the client device.

16. A method comprising:
receiving seed content, the seed content;
associating at least one content generation tag or at least one content criteria tag with the seed content;
indexing the seed content;
using the seed content to generate a web page on-demand based on a navigation request associated with a non-existent domain; and
providing the web page for display on a client device.

17. The method of claim 16, wherein the content generation tag indicates a style preference.

18. The method of claim 16, wherein the content criteria tag indicates a permitted use of the seed content.

19. The method of claim 16, wherein the content generation tag or the content criteria tag is associated with a profile of a content creator providing the seed content.

20. The method of claim 16, wherein a large foundational model is used to generate the web page based on the seed content and the content generation tag.

21. The method of claim 16, further comprising:
using the seed content to generate a link on a second web page, the link being generated using a navigational graph model; and
using the seed content to generate the web page in response to selection of the link.

22. The method of claim 16, wherein the seed content includes text lacking a finalized form.
